(19) United States
(12) Patent Application Publication
(10) Pub. No.: US 2026/0142911 A1
(43) Pub. Date: May 21, 2026

(54) Network Device Association Based on Random Sequences

(71) Applicant: Bradford T Hite, Valencia, CA (US)

(72) Inventor: Bradford T Hite, Valencia, CA (US)

(21) Appl. No.: 18/952,157

(22) Filed: Nov. 19, 2024

(51) Int. Cl. H04L 45/16; H04L 9/40; H04L 45/74; H04W 40/24

(52) U.S. Cl. CPC H04L 45/16; H04L 45/74; H04L 63/0428; H04W 40/246

(57) ABSTRACT

A unique system for the implementation of a communications system is presented whereby the association of network devices by address or identification assignment is based on competitive random sequences. Association of devices is carried out during a network initialization process whereby each connected device transmits a random sequence for competitive selection. Network devices contain a random number generator capable of generating a random sequence of numbers. These sequences are used to compete for unique address assignments by a network master for each device necessary to establish data transfer communications. This method of initialization eliminates the need for pre-defined hardware static network addresses commonly found in the art. Additionally, system security can be enhanced by having the ability to re-initialize randomly derived network device address or identification information.

### CROSS-REFERENCES TO RELATED APPLICATIONS

Not Applicable.

### STATEMENT REGARDING FEDERALLY SPONSORED RESEARCH OR DEVELOPMENT

Not Applicable.

### REFERENCES CITED

Not Applicable

### BACKGROUND OF THE INVENTION

### 1. Field of the Invention

This invention relates to the field of providing an association of network devices by address or identification information assignment. Association of devices is carried out during a network initialization process whereby each connected device transmits a random sequence for competitive selection. Network devices contain a random number generator capable of generating a random sequence of numbers. These sequences are used to compete for unique address assignments by a network master for each device necessary to establish data transfer communications. This method of initialization eliminates the need for pre-defined hardware static network addresses commonly found in the art. Additionally, system security can be enhanced by having the ability to re-initialize randomly derived network device address or identification information.

### 2. Description of the Related Art

The usage of static unique MAC addresses forms the basis for everyday communication interfaces Wi-Fi and Ethernet as called out in the IEEE 802 standard. A manufacturer unique MAC address subfield EUI-48 is pre-assigned to a specific entity or manufacturer by an industry-based registration authority for usage in network devices. This EUI-48 is further combined with an entity or manufacturer assigned subfield to complete the device MAC address. In this manner, each device is intended to contain a worldwide unique static MAC address assigned during manufacture to identify itself on a connected network. Current network system implementations have brought about inherent privacy concerns to protect user personally identifiable information and prevent user tracking/profiling. Usage of static never changing MAC addressing enables a persistent electronic trail allowing the determination of user locations, movements and contacts. The present invention is a system and method to address these unmet needs.

Current industry acknowledgement of these privacy issues has led to the development of standard IEEE 802.11hb. Using this standard, network devices can broadcast using randomized MAC addressing to prevent data gathering and analysis made possible by a static MAC address. This randomized addressing approach however brings about an associated set of issues affecting network usability in areas of device connectivity and disruption. An example would be the need for a portal user to repeatedly login or resubmit authentication information when the device goes idle, disconnects, and reconnects via a different MAC address. Further, continually changing device identities makes it difficult for network controls to identify legitimate users or which devices are actually connected to the network. Allowing each network device to randomly determine their own address in this manner without regard to network controls can cause network disruptions and erroneous performance. The present invention provides a system/method to address these unmet needs supporting both network privacy and reliability.

### BRIEF SUMMARY OF THE INVENTION

The present invention comprises a system/method for association of network devices based on competing random sequences. Connected network devices under synchronization of a network master each transmit a random sequence onto the network to compete for unique network address or identification information assignment. The transmitted random sequences are combined according to network protocols into a resultant composite sequence used to detect a collision or garble condition. The garble condition results when a device's transmitted sequence differs from the composite sequence. Upon detection of a garble condition, the transmitting device terminates participation in the competitive process. Iteratively, competing devices are eliminated until a single remaining device is assigned a unique network address or identification information. This process is repeated until network initialization is complete whereby all connected devices have unique addresses assigned prior to operation of the network for data communication between devices.

### BRIEF DESCRIPTION OF THE DRAWINGS

FIG. 1 is a system block diagram for the preferred embodiment of the present invention.

FIG. 2 is an example transaction diagram detailing a method for network device association using a fixed length synchronization period.

FIG. 3 is an example flowchart diagram associated with the method shown in FIG. 2.

FIG. 4 is an example transaction diagram detailing an alternate method for network device association using a fixed length garble free period.

FIG. 5 is an example flowchart diagram associated with the method shown in FIG. 4.

FIG. 6 is an example transaction diagram detailing multiple network initialization process iterations used to support data transaction encryption.

REFERENCE NUMERALS IN THE DRAWINGS

| | | | |
|---|---|---|---|
| 100 | Network Master | 102 | Network |
| | Communication Device | | Communication |
| | | | Device 1 |
| 104 | Device 1 Random Number | 106 | Network |
| | Generator | | Communication |
| | | | Device 2 |
| 108 | Device 2 Random Number | 110 | Network |
| | Generator | | Communication |
| | | | Device 3 |
| 112 | Device 3 Random | 114 | Communications |
| | Number Generator | | Network |
| 116 | Network | 118 | Device 4 Random |
| | Communication | | Number Generator |
| | Device 4 | | |
| 200 | Network Master | 202 | Network Device 1 |
| | Communication | | Communication |
| | (Device 1 Address | | (Device 1 Address |
| | Assignment Cycle) | | Assignment Cycle) |
| 204 | Network Device 2 | 206 | Network Device 3 |
| | Communication | | Communication |
| | (Device 1 Address | | (Device 1 Address |
| | Assignment Cycle) | | Assignment Cycle) |
| 208 | Network Device 4 | 210 | Network Master |
| | Communication | | Communication |
| | (Device 1 Address | | (Device 2 Address |
| | Assignment Cycle) | | Assignment Cycle) |
| 212 | Network Device 1 | 214 | Network Device 2 |
| | Communication | | Communication |
| | (Device 2 Address | | (Device 2 Address |
| | Assignment Cycle) | | Assignment Cycle) |
| 216 | Network Device 3 | 218 | Network Device 4 |
| | Communication | | Communication |
| | (Device 2 Address | | (Device 2 Address |
| | Assignment Cycle) | | Assignment Cycle) |
| 220 | Network Master | 222 | Network Device 1 |
| | Communication | | Communication |
| | (Device 3 Address | | (Device 3 Address |
| | Assignment Cycle) | | Assignment Cycle) |
| 224 | Network Device 2 | 226 | Network Device 3 |
| | Communication | | Communication |
| | (Device 3 Address | | (Device 3 Address |
| | Assignment Cycle) | | Assignment Cycle) |
| 228 | Network Device 4 | 230 | Network Master |
| | Communication | | Communication |
| | (Device 3 Address | | (Device 4 Address |
| | Assignment Cycle) | | Assignment Cycle) |
| 232 | Network Device 1 | 234 | Network Device 2 |
| | Communication | | Communication |
| | (Device 4 Address | | (Device 4 Address |
| | Assignment Cycle) | | Assignment Cycle) |
| 236 | Network Device 3 | 238 | Network Device 4 |
| | Communication | | Communication |
| | (Device 4 Address | | (Device 4 Address |
| | Assignment Cycle) | | Assignment Cycle) |
| 300 | Master Sends Bus | 302 | Master Starts |
| | Configuration Start | | Synchronization Clock |
| | Command Process Step | | Frame Process Step |
| 304 | Device(s) Start Random | 306 | Clock Frame Length |
| | Sequence Output | | Exceeded Decision |
| | Synchronized to Clock | | Step |
| | Process Step | | |
| 308 | Master Sends Clock | 310 | Device(s) Send |
| | Iteration Process Step | | Random Sequence Bit |
| | | | Process Step |
| 312 | Device(s) Test Resultant | 314 | Device Terminates |
| | Bit Equals Bit Sent | | Sending Random |
| | Decision Step | | Sequence Process |
| | | | Step |
| 316 | Master Write Device | 318 | Remaining Non- |
| | Address Process Step | | Garble Device Accepts |
| | | | Address Process Step |
| 320 | Remaining Non-Garble | 322 | Remaining Non- |
| | Device Enters Idle State | | Garble Device |
| | Process Step | | Acknowledges |
| | | | Address Process Step |
| 324 | Device Address | 326 | Master Sends Bus |
| | Acknowledge Received | | Configuration Stop |
| | Decision Step | | Command Process |
| | | | Step |
| 400 | Network Master | 402 | Network Device 1 |
| | Communication | | Communication |
| | (Device 1 Address | | (Device 1 Address |
| | Assignment Cycle) | | Assignment Cycle) |
| 404 | Network Device 2 | 406 | Network Device 3 |
| | Communication | | Communication |
| | (Device 1 Address | | (Device 1 Address |
| | Assignment Cycle) | | Assignment Cycle) |
| 408 | Network Device 4 | 410 | Network Master |
| | Communication | | Communication |
| | (Device 1 Address | | (Device 2 Address |
| | Assignment Cycle) | | Assignment Cycle) |
| 412 | Network Device 1 | 414 | Network Device 2 |
| | Communication | | Communication |
| | (Device 2 Address | | (Device 2 Address |
| | Assignment Cycle) | | Assignment Cycle) |
| 416 | Network Device 3 | 418 | Network Device 4 |
| | Communication | | Communication |
| | (Device 2 Address | | (Device 2 Address |
| | Assignment Cycle) | | Assignment Cycle) |
| 420 | Network Master | 422 | Network Device 1 |
| | Communication | | Communication |
| | (Device 3 Address | | (Device 3 Address |
| | Assignment Cycle) | | Assignment Cycle) |
| 424 | Network Device 2 | 426 | Network Device 3 |
| | Communication | | Communication |
| | (Device 3 Address | | (Device 3 Address |
| | Assignment Cycle) | | Assignment Cycle) |
| 428 | Network Device 4 | 430 | Network Master |
| | Communication | | Communication |
| | (Device 3 Address | | (Device 4 Address |
| | Assignment Cycle) | | Assignment Cycle) |
| 432 | Network Device 1 | 434 | Network Device 2 |
| | Communication | | Communication |
| | (Device 4 Address | | (Device 4 Address |
| | Assignment Cycle) | | Assignment Cycle) |
| 436 | Network Device 3 | 438 | Network Device 4 |
| | Communication | | Communication |
| | (Device 4 Address | | (Device 4 Address |
| | Assignment Cycle) | | Assignment Cycle) |
| 500 | Master Sends Bus | 502 | Master Starts |
| | Configuration Start | | Synchronization Clock |
| | Command Process Step | | Frame Process Step |
| 504 | Device(s) Start Random | 506 | Garble Free Time |
| | Sequence Output | | Length Exceeded |
| | Synchronized to Clock | | Decision Step |
| | Process Step | | |
| 508 | Master Sends Clock | 510 | Device(s) Send |
| | Iteration Process Step | | Random Sequence Bit |
| | | | Process Step |
| 512 | Device(s) Test Resultant | 514 | Device Sends Garble |
| | Bit Equals Bit Sent | | Status to Master |
| | Decision Step | | Process Step |
| 516 | Device Terminates | 518 | Master Write Device |
| | Sending Random | | Address Process Step |
| | Sequence Process Step | | |
| 520 | Remaining Non-Garble | 522 | Remaining Non-Garble |
| | Device Accepts | | Device Enters Idle State |
| | Address Process Step | | Process Step |
| 524 | Garble Status Received | 524 | Master Sends Bus |
| | During Last Frame | | Configuration Stop |
| | Decision Step | | Command Process |
| | | | Step |
| 600 | First iteration of rotating | 602 | Second iteration of |
| | random address | | rotating random |
| | generation | | address generation |
| 604 | Third iteration of rotating | | |
| | random address | | |
| | generation | | |

### DETAILED DESCRIPTION OF THE INVENTION

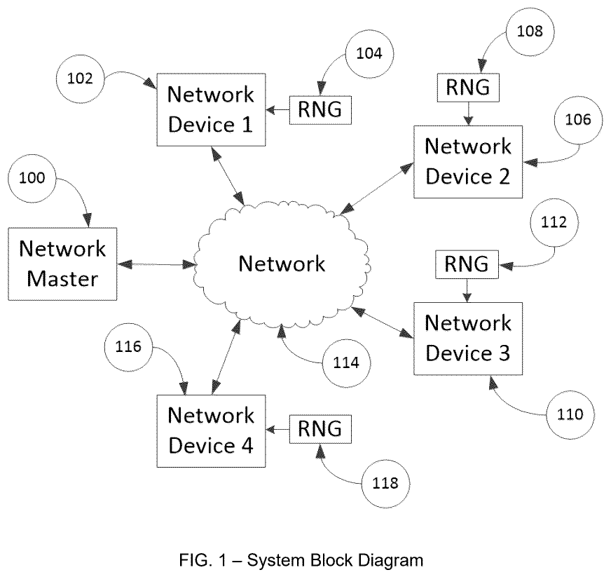

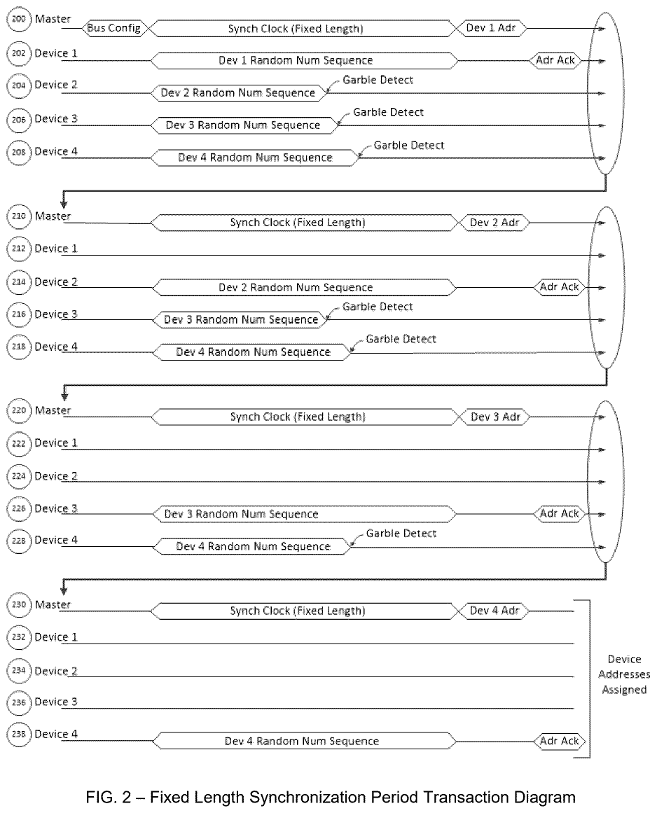

The preferred embodiment system block diagram of the present invention is shown in FIG. 1 as a communication network connecting a network master communication device and multiple network communication devices. Communications network 114 provides a data transfer media between network communication devices for exchanging information. Examples of network types are but not limited to 1) Bus or Multi-Drop topology to include one-wire, I2C, SPI, RS-485; 2) Star topology to include Ethernet, Wi-Fi; and 3) Tree topology being a combination of Bus/Star types. Network master communication device 100 initially serves to synchronize the network initialization process whereby device association is performed. Later during normal network data transfer operations, network master communication device 100 can serve to arbitrate network communications but is not necessary for all topologies. Examples of the network master communication device 100 can include: computer, router, switch, network interface integrated circuit, network interface card or any other type of network interface device. Network communication devices 102, 106, 110, 116 each have access to network 114 for data transfer. Further, each network communication device contains an integrated Random Number Generator (RNG) 104, 108, 112, 118 with capability of generating a random sequence of infinite length. Generally, any type of RNG function can be used to generate a random sequence with multiple types found in the art. One specialized type of RNG referred to as a True Random Number Generator uses a physical property such as thermal or electrical noise to generate a random sequence. Other types of RNG utilize a seeded polynomial circuit or a combination output of polynomial circuits to generate a pseudo random number. The RNG can be implemented in software, hardware or combination of to produce a random sequence. In the preferred embodiment, at initialization the network master communication device 100 will synchronize the output of a random sequence by each network communication device 102, 106, 110, 116 competing to produce an un-garbled sequence. Upon completion of the competitive cycle, a single non-garbled device will remain and be assigned its unique network address or identification information. The address or identification information assigned can consist of but is now limited to 1) unique token or numeric field created by the master; 2) an address based on the random sequence; and 3) an address conforming to the IEEE 802 standard. Continuing in this manner, each un-assigned communication device will compete until all communication devices have completed the network address or identification information assignment step. Upon completion of all communication devices having a network identification assigned, normal network data communications can commence based on being fully configured. Detailed examples of this process are provided based on either fixed length synchronization period or fixed length garble free period. In the following discussion of FIGS. 2-6, the terms network address and network identification information is used interchangeably.

FIG. 2 shows an example transaction diagram for a network initialization process to configure multiple connected network devices synchronized by a network master device of the preferred embodiment. This example is based on having a fixed synchronization clock period supplied by the network master whereby a competitive address assignment process is followed by each connected device. The fixed length synchronization clock period is designed to provide a minimum garble-free period at the end of the competitive process. Further, the competitive process consists of each connected device transmitting a unique random bit sequence combined to produce a composite resultant bit sequence. In the event the connected device's transmitted bit does not equal the resulting composite bit, the device declares a garble condition and is eliminated from the competitive process. Multiple competitive process cycles are required to effectively assign device addresses on a one-by-one basis. To simplify this discussion, the example is presented using a multi-drop network hardware topology whereby each network device connects via an open drain circuit to a common wire with single shared pull-up resister. In this manner for example as shown in FIG. 2, all transactions shown for steps 200-208 would occur interleaved on the same conductor. Other example more complex network electrical interface types can be supported given the ability to detect a garble condition between the competing connected devices. In the following discussion, preferred embodiment network devices 102, 106, 110, 116 are referred to as device 1, 2, 3, 4 respectively.

The process starts with step 200, whereby network master 100 issues a bus configuration command to all network 114 connected devices 1-4. Upon receipt of the bus configuration command each network connected device will start outputting a random number sequence under the synchronization of network master 100. Synchronization by network master 100 for this example consists of an interleaved clock signal alternating with the combined random sequence responses generated by each connected network device. The open drain outputs with shared pull-up resistor serve to form a logic AND function whereby a gable detection is performed if a specific network device requests a logic HIGH bit while a competing device requests a logic LOW. Each connected device can sample the network wire state retrieving the resultant composite bit and determine if a miss-match or gable has occurred. In the event a gable condition (request does not equal result) is detected by the specific network device it will terminate transmitting a random sequence and enter an idle state. This competitive operation is first shown at steps 202, 204, 206, 208 whereby each respective device 1-4 initiates a random sequence transmission under the synchronization of network master 100. First at step 204, device 2 detects a garble condition and terminates transmission by entering an idle state. Next at step 206, device 3 detects a garble condition and terminates transmission also entering an idle state. Next at step 208, device 4 detects a garble condition and terminates transmission also entering an idle state. Finally in step 202, device 1 is the remaining non-gable device continuing to transmit until the fixed length synchronization period terminates. At this time shown in step 200, the master device 100 sends out the unique network address for the remaining non-garble device 1. Device 1 then will acknowledge reception of the network address from the master device 100 and enter an idle state for the remaining network initialization process.

Steps 210, 212, 214, 216, 218 show a second iteration cycle of network initialization whereby device 1 is now idle. As above, first in step 216 device 3 detects a garble condition and terminates transmission entering an idle state. Next in step 218, device 4 detects a garble condition and terminates transmission also entering an idle state. Upon termination of the synchronization period, device 2 shown in step 214 is the remaining non-garble device and is assigned a unique network address by the master device 100 in step 210. Finally in step 214, the network address assignment is acknowledged by device 2. A third iteration cycle of network initialization is shown in steps 220, 222, 224, 226, 228 whereby devices 1 and 2 are now idle. First as shown in step 228, device 4 detects a garble condition and terminates transmission entering an idle state. Upon termination of the synchronization period, device 3 shown in step 226 as the remaining non-garble device and is assigned a unique network address by the master device 100 in step 220. Finally in step 226, the network address assignment is acknowledged by device 3. A fourth iteration of network initialization is shown in steps 230, 232, 234, 236, 238 whereby devices 1, 2 and 3 are now idle. With no competing devices, as shown in step 238, device 4 transmits during the entire synchronization period. Upon termination of the synchronization period, device 4 ceases transmission and is assigned a unique network address by the master device 100 in step 230. Finally in step 238, the network address assignment is acknowledged by device 4. During the final (not shown) cycle synchronization period, where all connected devices are in an idle mode, master device 100 will not receive an address acknowledge and terminate the network initialization process by sending a bus configuration stop command. At this point, all connected devices will have an assigned unique address and normal point/point network data transactions can commence.

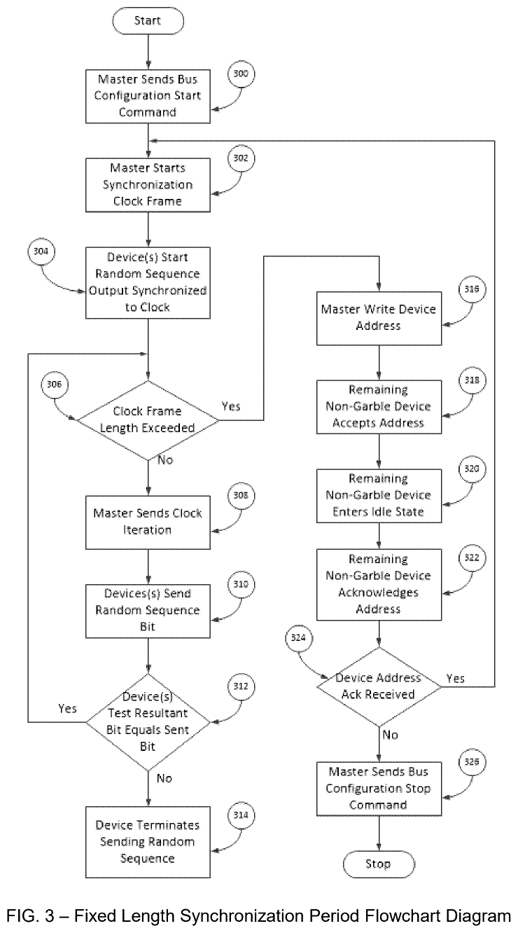

FIG. 3 shows a flow chart diagram associated with the process described with reference to FIG. 2. The process starts with step 300 whereby the network master sends a bus configuration command and starts a synchronization clock frame in step 302. All connected network devices now will start to output 304 an individual random sequence onto the network. Decision step 306 checks to determine if the synchronization clock frame length has been exceeded and terminates the current cycle. If the clock frame is still active, a loop is entered by each connected device to synchronize random sequence bit outputs to the master clock. The loop consists of the master sending a clock iteration 308 and each connected device responses with a random sequence iteration 310. At this point, each connected device tests for the composite resultant bit being equal 312 to the bit sent. If the bits are not equal, the associated connected device will detect the garble condition and cease random sequence transmission 314. Equality of the bits allows the associated connected device to continue in the competitive selection process based on the next master clock iteration. Upon completion of the competitive selection process only a single remaining non-garble device will remain.

Determination the synchronization clock period has been exceeded in step 306 will initiate a synchronization cycle termination. At this point, the master will write a unique device or network address 316 which is received by the remaining non-garble device 318. The non-garble device now enters an idle state 320 for the remaining network initialization process whereby its unique device or network address assignment has been made and no further random sequence transmission is performed. The final action for the non-garble device is to send a device or network address acknowledgement 322 back to the master indicating the synchronization cycle is complete. At this point, if the master receives an acknowledgement the next synchronization cycle is started, otherwise upon no acknowledgement is received the master will send a bus configuration stop command terminating the network initialization process. The process stops when each connected device has a unique device or network address allowing normal network data communications to proceed.

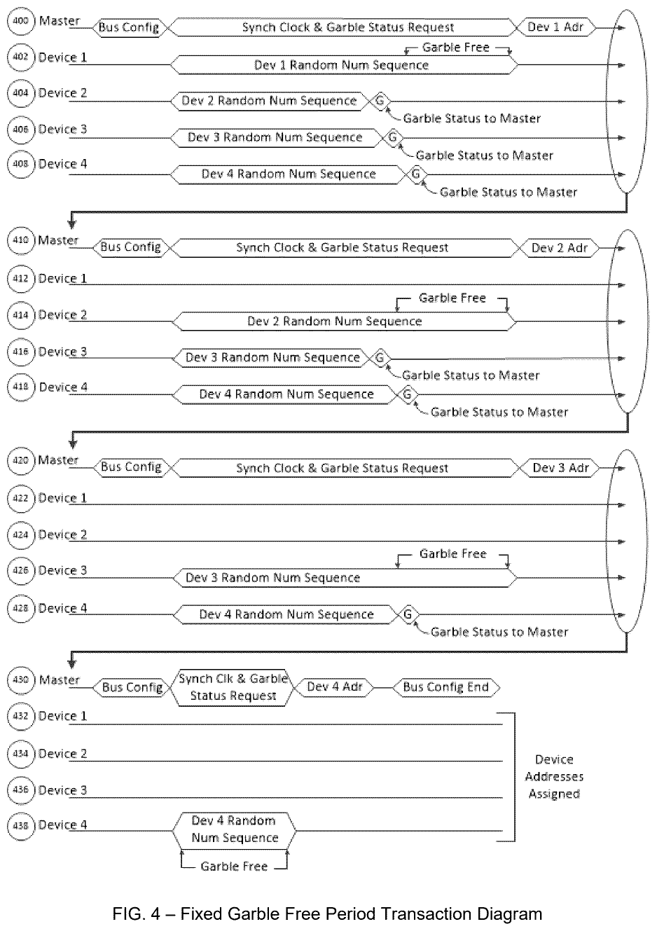

FIG. 4 shows an alternate example transaction diagram for a network initialization process to configure multiple connected network devices synchronized by a network master device of the preferred embodiment. This example is based on having each connected device sending a gable condition detection acknowledge to the network master whereby a competitive address assignment process is followed by each connected device. The synchronization clock period is designed to provide a minimum garble-free length period at the end of the competitive process. Further, the competitive process consists of each connected device transmitting a unique random bit sequence combined to produce a composite resultant bit sequence. In the event the connected device's transmitted bit does not equal the resulting composite bit, the device declares a garble condition sending an acknowledgement to the master and is eliminated from the competitive process. Multiple competitive process cycles are required to effectively assign device addresses on a one-by-one basis. Again, to simplify this discussion the example is presented using a multi-drop network hardware topology whereby each network device connects via an open drain circuit to a common wire with single shared pull-up resister. In this manner for example as shown in FIG. 4, all transactions shown for steps 400-408 occur interleaved on the same conductor. In the following discussion, preferred embodiment network devices 102, 106, 110, 116 are referred to as device 1, 2, 3, 4 respectively.

The process starts with step 400, whereby network master 100 issues a bus configuration command to all network 114 connected devices 1-4. Upon receipt of the bus configuration command each network connected device will start outputting a random number sequence under the synchronization of network master 100. Synchronization by network master 100 for this example consists of an interleaved clock signal plus garble status requests alternating with the combined random sequence responses generated by each connected network device. Each connected device can sample the network wire state retrieving the resultant composite bit and determine if a miss-match or gable has occurred. In the event a gable condition is detected by the specific network device it will respond to the master with a garble acknowledgement and terminate transmitting a random sequence entering an idle state. This competitive operation is shown at steps 400, 402, 404, 406, 408 whereby each connected device 1-4 initiates a random sequence transmission under the synchronization of network master 100. First at step 404, device 2 detects a garble condition, sends an acknowledgement to the master and terminates transmission. Next at step 406, device 3 detects a garble condition, sends acknowledgement and terminates transmission. Finally at step 408, device 4 detects a garble condition, sends an acknowledgement and terminates transmission. Now as shown in step 402, device 1 is the remaining non-garble device continuing to transmit until the garble free period terminates. At this time shown in step 400, the master device 100 sends out the unique address for the remaining non-garble device 1. Device 1 will now enter an idle state for the remaining network initialization process.

Steps 410, 412, 414, 416, 418 show a second iteration of network initialization whereby device 1 is now idle. As above, first in step 416 device 3 detects a garble condition, sends an acknowledgement and terminates transmission. Next in step 418, device 4 detects a garble condition, sends an acknowledgement and terminates transmission. At this time, device 2 shown in step 414 is the remaining non-garble device and assigned a unique network address by the master device 100 in step 410. A third iteration of network initialization is shown in steps 420, 422, 424, 426, 428 whereby devices 1 and 2 are now idle. First in step 428, device 4 detects a garble condition, sends an acknowledgement and terminates transmission. Upon termination of the garble free period, device 3 shown in step 426 as the remaining non-garble device and is assigned a unique network address by the master device 100 in step 420. A fourth iteration of network initialization is shown in steps 430, 432, 434, 436, 438 whereby devices 1, 2 and 3 are now idle. With no competing devices, as shown in step 438, only device 4 transmits during the entire garble free period. Upon termination of the garble free period, device 4 ceases transmission and is assigned a unique network address by the master device 100 in step 430. At this point, master device 100 will not receive a garble acknowledge and terminate the network initialization process. At this point, all connected devices will have an assigned unique address and normal point/point network data transactions can commence.

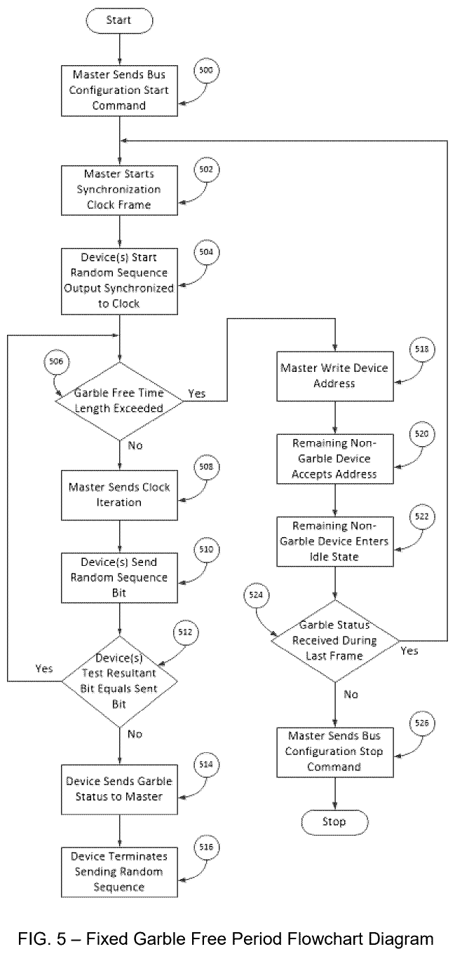

FIG. 5 shows a flow chart diagram associated with the process described with reference to FIG. 4. The process starts with step 500 whereby the network master sends a bus configuration command and starts a synchronization clock frame in step 502. All connected network devices now will start to output 504 an individual random sequence onto the network. Decision step 506 checks to determine if the garble free time length has been exceeded and terminates the current cycle. If the garble free period is still active, a loop is entered by each connected device to synchronize random sequence bit outputs to the master clock. The loop consists of the master sending a clock iteration 508 and each connected device responses with a random sequence iteration 510. At this point, each connected device tests for the competitive resultant bit being equal 512 to the transmitted bit. If the bits are not equal, the associated connected device will detect the garble condition, send garble status 514 to the network master and cease random sequence termination 516. Equality of the bits allows the associated connected device to continue in the competitive decision process based on the next master clock iteration. Upon completion of the competitive decision process only a single remaining non-garble device will remain.

Determination the garble free period has been exceeded in step 506 will initiate a synchronization cycle termination. At this point, the master will write a unique device or network address 518 which is received by the remaining non-garble device 520. The non-garble device now enters an idle state 522 for the remaining network initialization process whereby its unique device or network address assignment has been made and not further random sequence transmission is performed. At this point, if the master has received a garble acknowledgement the next synchronization cycle is started, otherwise upon no acknowledgement is received the master will send a bus configuration stop command terminating the network initialization process. The process stops when each connected device has a unique device or network address allowing normal network data communications to proceed.

The two examples as shown in FIG. 2 and FIG. 4 have been discussed with regard to a simple hardware implementation for clarity. Other more complex network topologies typically employ differential signaling and electrically buffered station/station data links. These type systems are also applicable to the present invention given proper methods used to detect a garble condition and synchronize the competitive selection process. For example, differential signaling transmitters are not compatible with the direct connection of stations being active simultaneously. A RS-485 type bus network required a single transmitter to be active at any time to avoid invalid data signaling representations. This type of network connection, for example, could require the network master device to synchronize/sample the output of each station's random sequence and construct the resultant sequence internally. After the resultant sequence is available, the network master device would then transmit it back to all stations for garble detection. Buffered data links add further difficulty to the synchronization process in that individual network routing connection paths must be maintained by the network master. For example in a star network, the network master device maybe a router or switch whereby each network station communicates via a dedicated port. In this case, each network station's random sequence would need to be associated with a fixed port or path for the entire network initialization process. Finally, the tree network topology adds layers to communication path routes, adding difficulty to maintain individual routing paths. Layers in the tree network would be normally separated by a device such as a router, switch or bridge requiring the ability to support the overall maintenance of individual station routing paths by the network master device. Each station across these more complex networks is treated as a single competitive selection process entry to iteratively assign network address or identification information.

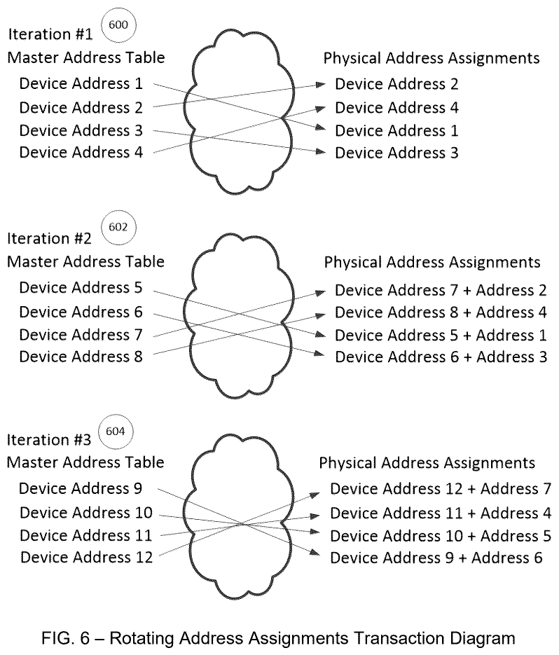

Encryption capabilities for the present invention are a natural benefit due to the random assignment of identification information to network devices. Performance of a repetitive periodic network initialization process supports a rotating encryption key implementation necessary for symmetric key cryptography. For each iteration of the network initialization processes, the competitive selection process of random sequences results in a random assignment order of identification information to each network device. Identification information can also be based on each random sequence during the iteration cycle to further enhance encryption capabilities. FIG. 6 shows an example multi-iteration network initialization process whereby network addresses or identification information is assigned to each device. In the first iteration 600, the network master assigns addresses in random order to network devices 1-4. Following in second iteration 602, a new set of network master addresses are again assigned in random order to network devices 1-4. Encrypted network communications can begin after iterations 600 and 602 using the first iteration group of assigned addresses to encrypt data communications between assigned devices address for the second iteration. In this manner, address 2 would be used to encrypt communications to/from device address 7, address 4 encrypts device 8 communications, address 1 encrypts device 5 communications and address 3 encrypts device 6 communications. The network master contains a last iteration device address table and can decrypt each device communication by a key search resulting in validated data. Following in third iteration 604, a new set of network master addresses are again assigned in random order to network devices 1-4. The last iteration group of addresses are again used on a rotational basis to encrypt data communications between network devices. Rotation of encryption keying based on periodic network initialization provides a robust method of data protection. Security of encrypted information by generating new traffic keys frequently during a communication session makes acquisition of any one traffic key useless.

The claimed invention is:

1. A system comprising:
a. a communication network coupled to a master communication device and at least two other communication devices, the communication network routing data in response to the communication devices;
b. a first communication device coupled to the communication network, the first communication device transmitting and receiving data in response to the communication network;
c. a second communication device coupled to the communication network, the second communication device transmitting and receiving data in response to the communication network;
d. wherein the first communication device is configured to generate first random sequence information, transmit the first random sequence information onto the communications network and receive first network identification information from the communications network; and
e. wherein the second communication device is configured to generate second random sequence information, transmit the second random sequence information onto the communications network and receive second network identification information from the communications network.

2. The system of claim 1, wherein each communication device is configured with network identification information consisting of a fixed token or numeric value.

3. The system of claim 1, wherein each communication device is configured with network identification information consisting of a random number derived from a random sequence.

4. The system of claim 1, wherein each communication device is configured with network identification information compliant with the IEEE 802 standard derived from a random sequence.

5. A method comprising:
a. routing data on a communication network in response to a master communication device and at least two other communication devices;
b. transmitting and receiving data by a first communication device in response to the communication network;
c. transmitting and receiving data by a second communication device in response to the communication network;
d. transmitting first random sequence information onto the communication network by the first communication device in response to a first random number generator;
e. receiving first communication device network identification information from the communication network by the first communication device based on the transmitted first random sequence information;
f. transmitting second random sequence information onto the communication network by the second communication device in response to a second random number generator; and
g. receiving second communication device network identification information from the communication network by the second communication device based on the transmitted second random sequence information.

6. The method of claim 5, further comprising generating communication device network identification information consisting of a fixed token or numeric value.

7. The method of claim 5, further comprising generating communication device network identification information consisting of a random number derived from a random sequence.

8. The method of claim 5, further comprising generating communication device network identification information compliant with the IEEE 802 standard derived from a random sequence.

9. A system comprising:
a. a communication network coupled to a master communication device and at least two other communication devices, the communication network routing data in response to the communication devices;
b. a first communication device coupled to the communication network, the first communication device transmitting and receiving encrypted data in response to the communication network;
c. a second communication device coupled to the communication network, the second communication device transmitting and receiving encrypted data in response to the communication network;
d. wherein the first communication device is configured during a first iteration to generate first random sequence information, transmit the first random sequence information onto the communications network and receive first network identification information from the communications network;
e. wherein the second communication device is configured during the first iteration to generate second random sequence information, transmit the second random sequence information onto the communications network and receive second network identification information from the communications network.
f. wherein the first communication device is configured during a second iteration to generate third random sequence information, transmit the third random sequence information onto the communications network, receive third network identification information from the communications network, and use the first network identification information to encrypt further network data communications by the first communication device identified by the third network identification information; and
g. wherein the second communication device is configured during the second iteration to generate fourth random sequence information, transmit the fourth random sequence information onto the communications network, receive fourth network identification information from the communications network and use the second network identification information to encrypt further network data communications by the second communication device identified by the fourth network identification information.
